(19) United States
(12) Patent Application Publication
(10) Pub. No.: US 2016/0148000 A1
(43) Pub. Date: May 26, 2016

(54) METHOD AND APPARATUS FOR ENCODING IMAGE DATA

(71) Applicants: ROBERT CRISTIAN KRUTSCH, MUNICH (DE); RAFAL KRZYSZTOF MALEWSKI, MOU (DK); MICHAEL ANDREAS STAUDENMAIER, MUNICH (DE); THOMAS RICHARDSON TEWELL, AUSTIN, TX (US)

(72) Inventors: ROBERT CRISTIAN KRUTSCH, MUNICH (DE); RAFAL KRZYSZTOF MALEWSKI, MOU (DK); MICHAEL ANDREAS STAUDENMAIER, MUNICH (DE); THOMAS RICHARDSON TEWELL, AUSTIN, TX (US)

(73) Assignee: FREESCALE SEMICONDUCTOR, INC., Austin, TX (US)

(21) Appl. No.: 14/553,173

(22) Filed: Nov. 25, 2014

(51) Int. Cl. G06F 21/60; G06K 9/36

(52) U.S. Cl. CPC G06F 21/602; G06K 9/36

(57) ABSTRACT

The present invention relates to a method and apparatus for encoding image data defining a graphics object. The method comprises partitioning the graphics object into a plurality of sub-images, deriving digital image data for each sub-image, the digital image data defining the respective sub-image, deriving sub-image position data defining the relative positioning of the sub-images within the graphics object, scrambling the digital image data for the plurality of sub-images, encrypting sub-image position data, and outputting encoded image data defining the graphics object comprising the scrambled sub-image data and the encrypted sub-image position data.

### FIELD OF THE INVENTION

This invention relates to a method and apparatus for encoding image data.

### BACKGROUND OF THE INVENTION

In the field of computer graphics, there is often a need to provide protection and security against image data being copied. For example, in the automotive industry a typical cluster and infotainment system uses computer graphics made up of multiple layers of artwork to display information etc. to a user. In some cases, around 10 GB of textures may be combined to generate a composite image to display to a user, with many masking layers being used to provide desired shadow and light effects. A significant amount of work, often carried out by a dedicated team of people, is required to generate the artwork, optimise the layers and introduce the details (e.g. gradients, shadows, light effects, etc.) in order to produce the desired, uniform visual effect. Accordingly, there is significant commercial value within the image data used within such cluster and infotainment systems.

FIG. 1 schematically illustrates a flow diagram illustrating the data flow and processing operations for a state of the art approach to the secure storage and subsequent display of image data, such as is conventionally implemented within a cluster and infotainment system. Image data 105 defining individual graphics objects is encrypted and stored within non-volatile memory such as Flash memory 110 illustrated in FIG. 1. Encrypted image data 105 for graphics objects required to be displayed is loaded into system memory such as RAM (random access memory) 120 from where it may be processed etc. The encrypted data 105 to be displayed is then read by a central processing unit (CPU) 130, which decrypts the image data, and writes the decrypted image data 135 back to RAM 120. A graphics processing unit (GPU) 140 is then able to read the decrypted image data, and generate a composite image ‘scene’ to be displayed from the decrypted image data 135. The composite image scene data 145 is then made available to a display controller 150 for displaying on a display 160 to a user.

In a cluster and infotainment system, such a composite image scene may be generated from a large number of individual graphics objects, for example representing background images, foreground images, icons for messages, errors and warnings, dials, etc. Furthermore, such a composite image scene may be adapted depending on various conditions such as whether it is daytime or night time, a selected profile (e.g. comfort, sport, etc.). As the amount of information required to be displayed by modern cluster and infotainment systems increases, the amount of image data required to enable such information to be displayed increases significantly.

A problem with the implementation illustrated in FIG. 1 is the high number of RAM accesses that are required, which requires a significant bus overhead and can have a significant detrimental effect on the overall system performance. Furthermore, as the amount of image data required increases, the amount of image data decryption required to be performed by the CPU 130 increases, increasing the load on the CPU 130.

A prior art solution proposed in Chapter 36 of “GPU Gems 3”, written by Hubert Nguyen, comprises providing an AES (Advanced Encryption Standard) implementation within the GPU 140, thereby allowing the GPU 140 to perform the task of decrypting the image data. In this manner, the read/write accesses by the CPU 130 would no longer be required, reducing the bus overhead as well as reducing the load on the CPU 130. However, such an implementation would require a high end GPU, which is not feasible within embedded applications such as those used in the automotive industry for cluster and infotainment systems.

### SUMMARY OF THE INVENTION

The present invention provides a method of encoding image data defining a graphics object, a processing device for encoding image data defining graphics objects, a method of generating image data for display, a processing device for generating image data for display and a non-transitory computer program product having executable program code stored therein as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 schematically illustrates a flow diagram illustrating the data flow and processing operations for a state of the art approach to the secure storage and subsequent display of image data.

FIG. 2 illustrates a simplified schematic diagram of a multi-core system on chip.

FIG. 3 schematically illustrates a flow diagram showing an example of data flow and processing operations for the secure storage and subsequent display of image data.

FIG. 4 schematically illustrates a flow diagram showing an example of the encoding of digital image data defining a graphics object.

FIG. 5 schematically illustrates a flow diagram showing an alternative example of data flow and processing operations for the secure storage and subsequent display of image data.

FIG. 6 schematically illustrates a flow diagram showing a further alternative example of data flow and processing operations for the secure storage and subsequent display of image data.

FIG. 7 illustrates a simplified flowchart of an example of a method of encoding image data defining a graphics object.

FIG. 8 illustrates a simplified flowchart of an example of a method of generating image data for display.

FIG. 9 schematically illustrates a simplified block diagram of a graphics object partitioned into sub-images.

FIG. 10 illustrates a simplified flowchart of an alternative example of a method of encoding image data defining a graphics object.

FIG. 11 illustrates a simplified block diagram of an example of a processing device for generating image data for display.

### DETAILED DESCRIPTION OF THE PREFERRED EMBODIMENTS

The present invention will now be described with reference to the accompanying drawings, and in particular with reference to a multi-core system on chip comprising a general processing unit arranged to generate image data for display in accordance with some examples of one aspect of the present invention. However, it will be appreciated that such an aspect of the present invention is not limited to being implemented within a system on chip device, and may equally be implemented within alternative forms of processing devices, and in particular within alternative forms of data processing integrated circuit devices such as, say, general purpose microprocessors, microcontrollers, network processors, digital signal processor (DSP).

Furthermore, because the illustrated embodiments of the present invention may for the most part, be implemented using electronic components and circuits known to those skilled in the art, details will not be explained in any greater extent than that considered necessary as illustrated below, for the understanding and appreciation of the underlying concepts of the present invention and in order not to obfuscate or distract from the teachings of the present invention.

In summary, some examples of the present invention comprise a method and apparatus for encoding image data defining a graphics object. The method comprises partitioning the graphics object into a plurality of sub-images, deriving digital image data for each sub-image, the digital image data defining the respective sub-image, deriving sub-image position data defining the relative positioning of the sub-images within the graphics object, scrambling the digital image data for the plurality of sub-images, encrypting sub-image position data, and outputting encoded image data defining the graphics object comprising the scrambled sub-image data and the encrypted sub-image position data.

In this manner, the original graphics object may be recreated by de-scrambling the sub-image data in accordance with the (un-encrypted) sub-image position data, and re-combining the sub-images in their appropriate relative positions. However, because the sub-image position data is encrypted, recreating the original graphics object from the encoded data is made difficult without the ability to decrypt the encrypted sub-image position data. Thus, protection and security is provided to the graphics object against image data being copied.

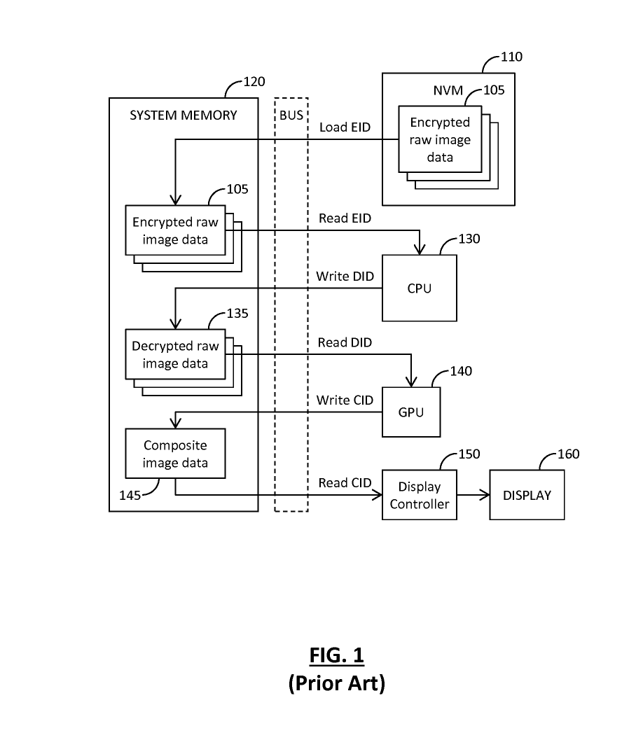

Significantly, only the sub-image position data for each graphics object is encrypted, representing only a small fraction of the complete information for each graphics object. As such, the processing overhead required for decryption, a processing heavy task, is considerably reduced compared with that of the prior art solution illustrated in FIG. 1 and described above in the background of the invention, which requires the complete information for every graphics object to be decrypted.

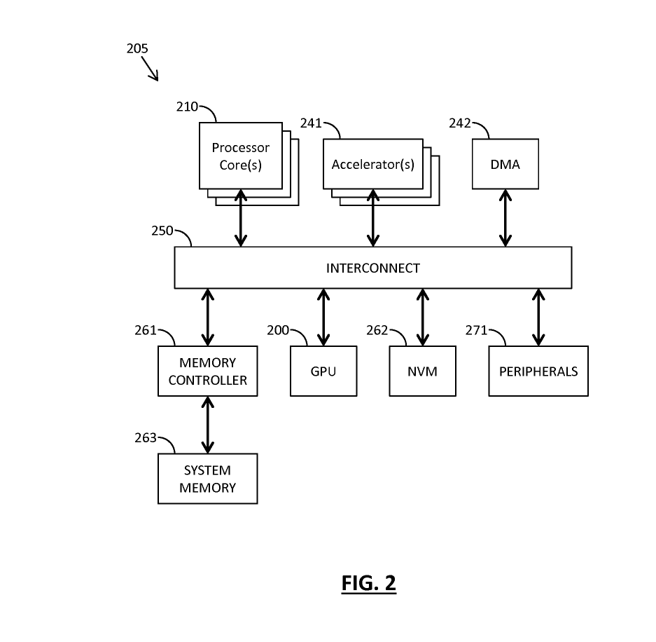

Referring now to FIG. 2, there is illustrated a simplified schematic diagram of a multi-core system on chip (SoC) 205 comprising multiple processor cores illustrated generally at 210. While the processor cores 210 may be identically designed or homogenous, the multi-core SoC 205 may also include one or more cores having a different design. For example, the depicted multi-core SoC 205 may also comprise one or more accelerators 241 which may comprise one or more processor cores for supporting hardware acceleration for, say, DFT/iDFT and FFT/iFFT algorithms, CRC processing, etc. Each processor core 210, 241 is coupled across an interconnect bus 250 to one or more memory controllers 261, which are coupled in turn to one or more banks of system memory, illustrated generally at 263. In the illustrated example, the interconnect bus 250 also couples the processor cores 210, 241 to a Direct Memory Access (DMA) controller 242, a graphics processing unit (GPU) 200, on-chip non-volatile memory 262, and to other hardware-implemented integrated peripherals illustrated generally at 271. It will be appreciated that the interconnect bus 250 may couple the processor cores 210, 241 to other components within the SoC 205 not illustrated in FIG. 2, such as, for example, network interfaces, serial interfaces, etc.

Each of the processor cores 210, 241 may be configured to execute instructions and to process data according to a particular instruction set architecture (ISA), such as x86, PowerPC, SPARC™, MIPS™, and ARM™, for example. Those of ordinary skill in the art also understand the present invention is not limited to any particular manufacturer's microprocessor design. The processor core may be found in many forms including, for example, any 32-bit or 64-bit microprocessor manufactured by Freescale™, Motorola™, Intel™, AMD™, Sun™ or IBM™. However, any other suitable single or multiple microprocessors, microcontrollers, or microcomputers may be utilized. In addition, the term “core” refers to any combination of hardware, software, and firmware typically configured to provide a processing functionality with respect to information obtained from or provided to associated circuitry and/or modules (e.g., one or more peripherals, as described below). Such cores include, for example, digital signal processors (DSPs), central processing units (CPUs), microprocessors, and the like. These cores are often also referred to as masters, in that they often act as a bus master with respect to any associated peripherals.

The processor cores 210 and accelerator(s) 241 are in communication with the interconnect bus 250 which manages data flow between the cores 210, 241 and memory. The interconnect bus 250 may be configured to concurrently accommodate a large number of independent accesses that are processed on each clock cycle, and enables communication data requests from the processor cores 210, 214 to system memory 263 and/or an on-chip non-volatile memory 262, as well as data responses therefrom. In selected embodiments, the interconnect bus 250 may include logic (such as multiplexers or a switch fabric, for example) that allows any core 210, 241 to access any bank of memory, and that conversely allows data to be returned from any memory bank to any core 210, 241. The interconnect bus 250 may also include logic to queue data requests and/or responses, such that requests and responses may not block other activity while waiting for service. Additionally, the interconnect bus 250 may be configured as a chip-level arbitration and switching system (CLASS) to arbitrate conflicts that may occur when multiple cores attempt to access a memory or vice versa.

Memory controller 261 is arranged to provide access to the optional SoC internal (on-chip) non-volatile memory 262 or system memory 263. For example, memory controller 261 may be configured to manage the transfer of data between the multi-core SoC 205 and system memory 263. In some embodiments, multiple instances of memory controller 261 may be implemented, with each instance configured to control a respective bank of system memory 263. Memory controller 261 may be configured to interface to any suitable type of system memory, such as Double Data Rate or Double Data Rate 2 or Double Data Rate 3 Synchronous Dynamic Random Access Memory (DDR/DDR2/DDR3 SDRAM), or Rambus DRAM (RDRAM), for example. In some embodiments, memory controller 261 may be configured to support interfacing to multiple different types of system memory. In addition, the Direct Memory Access (DMA) controller 242 may be provided which controls the direct data transfers to and from system memory 263 via memory controller 261.

In the illustrated example, the multi-core SoC 205 comprises a dedicated GPU 200. The GPU 200 may be configured to manage the transfer of data between the multi-core SoC 205 and the GPU 200, for example, through the interconnect bus 250. The GPU 200 may include one or more processor cores for supporting hardware accelerated graphics generation. The graphics generated by the GPU 200 may be outputted to one or more displays via any display interface such as low-voltage differential signalling (LVDS), high definition multimedia interface (HDMI), digital visual interface (DVI) and the like.

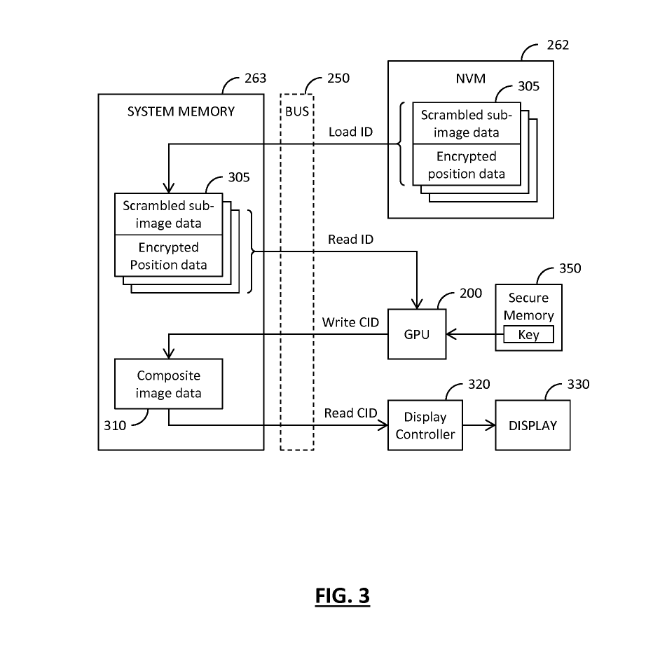

Referring now to FIG. 3, there is schematically illustrated a flow diagram showing an example of the data flow and processing operations for the secure storage and subsequent display of image data, such as may be implemented within the SoC 205 illustrated in FIG. 2. Encoded image data 305 defining individual graphics objects is stored within non-volatile memory, such as the non-volatile memory 262 of the SoC 205. Such graphics objects may comprise, for example in an automotive cluster and infotainment system, background images, foreground images, icons for messages, errors and warnings, dials, etc. In the example illustrated in FIG. 3, the encoded image data 305 defining a graphics object comprises scrambled digital image data defining a plurality of sub-images and encrypted sub-image position data.

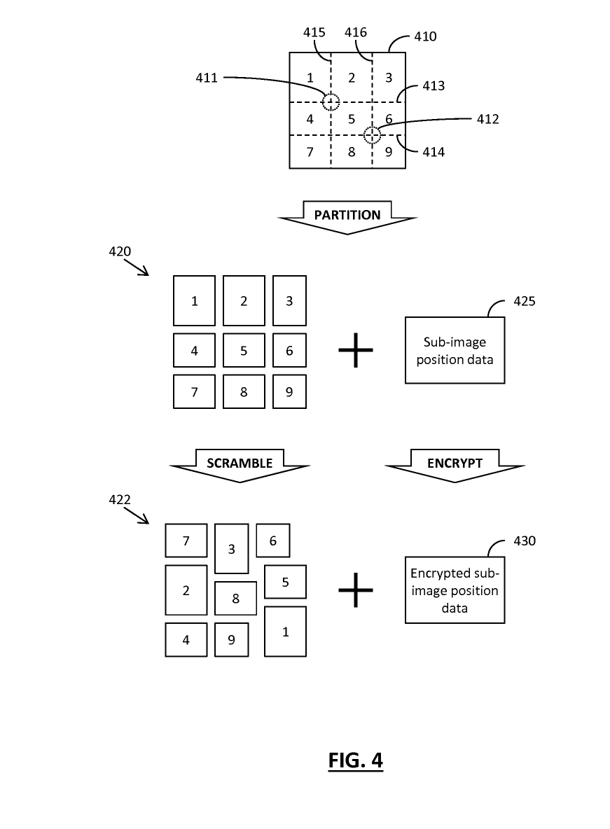

FIG. 4 schematically illustrates a flow diagram showing an example of the encoding of digital image data defining a graphics object 410 to produce encoded image data 305 therefor such as may be stored within the non-volatile memory 262. In some examples, the digital image data defining the graphics object 410 may comprise raw pixel data such as, say, RGBA (Red, Green, Blue and Alpha) image data. The first part of the example encoding process illustrated in FIG. 4 comprises partitioning the graphics object 410 into a plurality of sub-images, the sub-images being numbered 1 to 9 in the example illustrated in FIG. 4. Such partitioning may be performed in any suitable manner. For example, dissection points within the graphics object 410 may be determined, such as points 411, 412 indicated in FIG. 4. Such dissection points 411, 412 may be determined in any suitable manner. For example, such dissection points 411, 412 may correspond to predefined coordinates, or coordinates derived based on predefined criteria such as graphics object size, type, or other attribute. Alternatively, in some examples it is contemplated that such dissection points 411, 412 may be determined based on randomly derived coordinates. In this manner, and as described in greater detail below, recreating the original graphics object 410 from the encoded image data 305 is made less predictable, thereby improving the protection and security provided by the encryption against the copying of the graphics object 410. Having determined the dissection points 411, 412, horizontal and vertical dissecting lines 413, 414, 415, 416 passing through the dissection points 411, 412 may then be used to dissect the graphics object 410 into the plurality of sub-images. Digital sub-image data 420, for example comprising raw image data such as RGBA data, for each sub-image may then be generated from the digital image data defining the graphics object 410. Sub-image position data 425 defining the relative positioning of the sub-images 420 within the original graphics object 410 is also generated in order to enable the original graphics object 410 to subsequently be recreated from the digital sub-image data 420 for the plurality of sub-images.

The next part of the example encoding process illustrated in FIG. 4 comprises scrambling the digital sub-image data 420 for the plurality of sub-images, for example as illustrated at 422. Any suitable scrambling function may be applied to the digital sub-image data 420 that results in the relative positioning of the sub-images 420 being changed (e.g. re-ordered) such that the relative position of the sub-images 420 within the original graphics object 410 is obfuscated. It is considered that a person skilled in the art would easily be able to implement such a scrambling function without any difficulty. Nevertheless, for completeness one possible example of such a scrambling function may comprise sequentially performing a ‘swap’ operation on the data for each sub-image 420, whereby the sub-image data for the subject sub-image 420 is ‘swapped’ with the sub-image data for another randomly selected sub-image 420.

In some example embodiments, it is contemplated that the process of scrambling the digital sub-image data 420 may additionally comprise rotating some or all of the sub-images. Additionally/alternatively, it is contemplated that if the digital sub-image data 420 comprises the same information for two or more of the sub-images, the scrambled digital image data defining the plurality of sub-images 422 need only comprise one instance of the digital sub-image data 420 defining the two or more sub-images. In such a case, the sub-image position data 430 may define multiple positions for a single instance of digital sub-image data 420 within the original graphics object 410.

The example encoding process illustrated in FIG. 4 further comprises encrypting the sub-image position data 425. In this manner, the example encoding process illustrated in FIG. 4 results in the generation of encoded image data 305 comprising:

(i) scrambled digital image data defining a plurality of sub-images 422; and

(ii) encrypted sub-image position data 430.

The original graphics object 410 may easily be recreated by de-scrambling the sub-image data 422 in accordance with the (un-encrypted) sub-image position data 425, and re-combining the sub-images 420 in their appropriate relative positions. However, because the sub-image position data 425 is encrypted, recreating the original graphics object 410 from the encoded data 305 is made extremely difficult without the ability to decrypt the encrypted sub-image position data 430. For example, assuming a case where an attacker is able to take pictures of a displayed (composite) image, and to capture the scrambled digital image data 422 defining the sub-images 420 for a graphics object 410. If the attacker were to employ a brute force algorithm to reconstruct the original graphics object 410, for the illustrated simplified example of FIG. 4 in which the graphics object 410 has been partitioned into nine sub-images, there would be 9! (nine factorial) possible combinations (i.e. a total of 362880 possible combinations). It is contemplated that in a practical implementation, a graphics object may be partitioned into significantly more sub-images. Take for example the case where a graphics object is partitioned into 1280×800 sub-images. This would result in a total of 64000! (sixty four thousand factorial) possible combinations for reconstructing the scrambled sub-images 422 into the original graphics object 410. Accordingly, simply by scrambling the sub-images 420 and encrypting the position data 425 provides a significant level of protection and security against the graphics object 410 being recreated by an unauthorised party.

In some examples, it is contemplated that different scrambling functions are applied to the sub-image position data 420 for different graphics objects. In this manner, even if an attacker manages to obtain the sub-image position data 425 for descrambling the scrambled sub-image data 422 for one graphics object 410, the obtained sub-image position data 425 will not enable the attacker to de-scramble the sub-image data 420 for all graphics objects 410. For example, as described above the scrambling function may comprise sequentially performing a swap operation on the sub-image data for each sub-image 420, whereby the sub-image data for the subject sub-image is swapped with the sub-image data for another randomly selected sub-image 420. As such, the swapping of sub-images 420 is performed in a substantially random manner, resulting in the scrambling of the sub-image data 420 being performed in a substantially random way.

The encryption of the sub-image position data 425 may be performed based on any suitable encryption methodology. One simple example encryption approach comprises a key correlation approach. However, it will be appreciated that the present invention is not limited to any specific encryption methodology, and a person skilled in the art would easily be able to implement such encryption based on various different decryption strategies.

In the example illustrated in FIG. 4, partitioning of the graphics object 410 has been illustrated and described based on horizontal and vertical dissection lines running through two dissection points 411, 412. However, it will be appreciated that this example embodiment of the present invention is not limited to partitioning a graphics objects based on two dissection points, and it is contemplated that any suitable number of dissection points may be used. In some examples, it is contemplated that the partitioning of a graphics objects may be based on significantly more than two dissection points, for example resulting in a graphics objects being partitioned into hundreds, or even thousands, of sub-images. Furthermore, the example embodiment of the present invention illustrated in FIG. 4 is not limited to partitioning a graphics objects based on horizontal and vertical dissecting lines running through each determined dissection point. For example, it is contemplated that partitioning may be performed based only on vertical dissecting lines running through some or all of the determined dissection points and/or only on horizontal dissecting lines running through some or all of the determined dissection points.

Furthermore, it will be appreciated that the present invention is not limited to partitioning the graphics object based on dissection points. For example, the graphics object 410 may be partitioned based on predefined or dynamically (e.g. randomly) defined sub-image block sizes.

Referring back to FIG. 3, the encoded image data 305 comprises, for each graphics object defined thereby, scrambled sub-image data 422 and encrypted sub-image position data 430. Encoded image data 305 for graphics objects required to be displayed is loaded into system memory 263, via interconnect bus 250, from where it may be processed etc. for display.

In the example illustrated in FIG.'S 3 and 4, only the sub-image position data 425 for each graphics object 410 is encrypted, representing only a small fraction of the complete information for each graphics object 410, e.g. 2-3%. As such, the processing overhead required for decryption, a processing heavy task, is considerably reduced compared with that of the prior art solution illustrated in FIG. 1 and described above in the background of the invention, which requires the complete information for every graphics object to be decrypted.

Having decrypted the encrypted the sub-image position data 430 for a graphics object 410, the de-scrambling of the scrambled sub-image data 422 for the graphics object 410 is a relatively simple task, requiring minimal processing overhead. Significantly, the processing overhead required for the reduced decryption and de-scrambling of the encoded image data 305 in the example illustrated in FIG.'S 3 and 4 is sufficiently reduced as compared with the prior art solution of FIG. 1 that even a low-end GPU 200, such as typically used within embedded applications, is capable of performing such decryption and de-scrambling itself, alongside its other processing tasks. For example, conventional GPUs utilise procedural shaders to implement a graphics pipeline. Procedural shaders are specialized processing subunits of the GPU 200 for performing specialized operations on graphics data. An example of a procedural shader is a vertex shader, which generally operates on vertices. For instance, the vertex shader can apply computations of positions, colours and texturing coordinates to individual vertices. The vertex shader may perform either fixed or programmable function computations on streams of vertices specified in the memory of the graphics pipeline. Another example of a procedural shader is a pixel shader. For instance, the outputs of the vertex shader can be passed to the pixel shader, which in turn operates on each individual pixel. In some examples, it is contemplated that the decryption and de-scrambling of the encoded image data 305 may be performed by one or more of the procedural shaders utilised by the GPU 200, for example the vertex shader.

Accordingly, in the example illustrated in FIG. 3, the encoded image data 305 for each graphics object to be displayed may be read by the GPU 200, without the need for any decryption or other processing to have been previously performed by one of the processing cores 210. For each of the graphics objects to be displayed, the GPU 200 is then able to decrypt the encrypted sub-image position data and re-combine the sub-images to obtain the graphics object. In the example illustrated in FIG. 3, the GPU 200 is operably coupled to an area of secure memory 350, for example an area of memory not accessible to other components within the SoC 205 such as the processing cores 210, within which a decryption key for decrypting the encrypted sub-image position data.

In some alternative examples, encryption/decryption techniques may be implemented that do not require a decryption key to be stored for decrypting the encrypted sub-image position data. For example, physical clonable functions may be embedded within hardware.

The GPU 200 may then generate a composite image to be displayed based on the individual graphics objects, for example representing background images, foreground images, icons for messages, errors and warnings, dials, etc. Furthermore, such a composite image may be adapted depending on various conditions such as whether it is daytime or night time, a selected profile (e.g. comfort, sport) etc. The image data 310 for the composite image is then made available to a display controller 320 for displaying on a display 330, for example by way of the GPU 200 writing the image data 310 for the composite image back to system memory 263.

In the example illustrated in FIG. 3, the encoded image data 305 for each graphics object to be displayed may be read by the GPU 200, without the need for any decryption or other processing to have been previously performed by one of the processing cores 210. As a result, there is no need for encoded image data to be processed by a processing core 210, reducing bus and processing overhead. Furthermore, there is no need for image data to be stored twice (e.g. in encrypted and decrypted form) within the system memory 263, thereby reducing the memory requirements for displaying graphics objects.

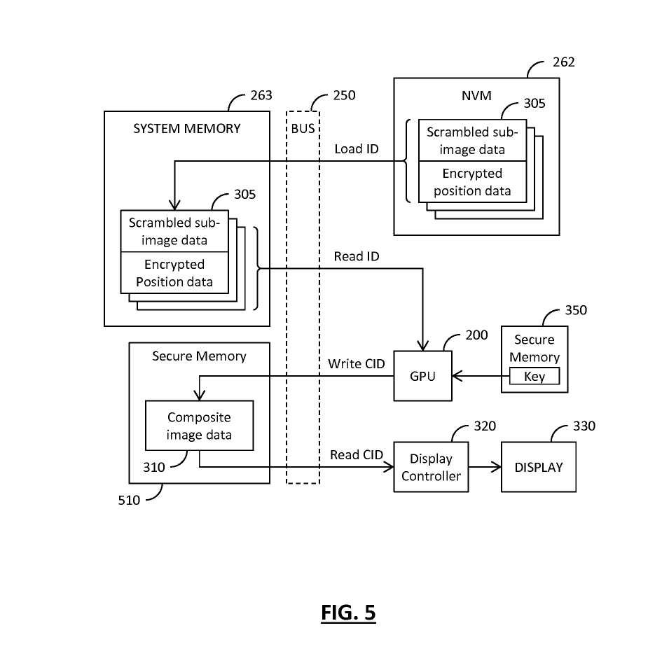

Referring now to FIG. 5, there is schematically illustrated a flow diagram showing an alternative example of the data flow and processing operations for the secure storage and subsequent display of image data, such as may be implemented within the SoC 205 illustrated in FIG. 2. The data flow and processing operations of the example illustrated within FIG. 5 are substantially the same as those for the example illustrated in FIG. 3, with the exception of the GPU 200 making the image data 310 for the composite image available to the display controller 320 by way of writing the image data 310 for the composite image to a secure area of memory 510, for example an area of memory not accessible to non-display related components within the SoC 205 such as the processing cores 210. Such a secure area of memory 510 may comprise, say, a protected area of system memory 263 with access limited to the GPU 200 and the display controller 320. Alternatively, the secure area of memory 510 may comprise a separate memory element such as a display buffer or the like. In this manner, an additional layer of security and protection may be provided to the image data.

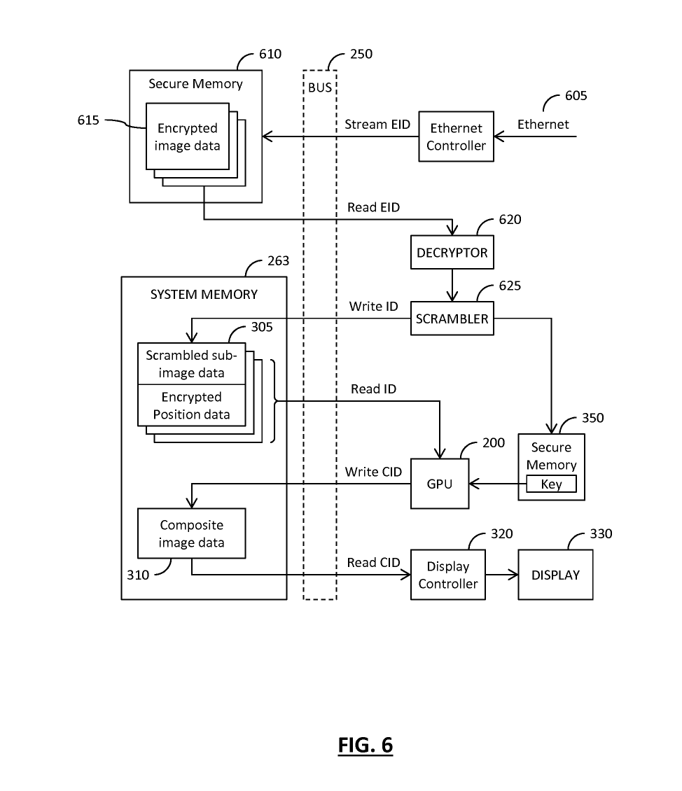

Referring now to FIG. 6, there is schematically illustrated a flow diagram showing a further alternative example of the data flow and processing operations for the secure storage and subsequent display of image data, such as may be implemented within the SoC 205 illustrated in FIG. 2. In the example illustrated in FIG. 6, image data is streamed to the SoC 205, for example via an Ethernet connection 610 or the like. In the illustrated example, received image data is initially stored within an area of secure memory 610, for example an area of memory not accessible to other components within the SoC 205 such as the processing cores 210. In some examples, it is contemplated that the streamed data may be encrypted to provide security and protection for the graphics objects defined by the streamed image data. Accordingly, in the example illustrated in FIG. 6, the received (encrypted) image data, indicated at 615, is read by a decryption module 620, which decrypts the image data and forwards the decrypted image data to a scrambling module 625. The scrambling module 625 is arranged to receive the decrypted image data defining graphics objects to be displayed, and for each such graphics object:
partition the graphics object into a plurality of sub-images;
generate digital sub-image data defining each sub-image and sub-image position data defining the relative positioning of the sub-images 420 within the original graphics object;
scramble the digital sub-image data for the plurality of sub-images; and
encrypt the sub-image position data.

In the illustrated example, the decryption module 620 and the scrambling module 625 have been illustrated as comprising discrete component for ease of understanding. However, it will be appreciated that they may equally be implemented jointly within a single hardware component.

The scrambling module 625 writes the encoded image data 305 for each graphics object comprising the scrambled digital sub-image data and the encrypted sub-image position data into system memory 263, from where it may be processed etc. for display. In the example illustrated in FIG. 3, the scrambling module 625 is further arranged to write a decryption key into a secure area of memory 350 accessible by the GPU 200. In the example illustrated in FIG. 6, the scrambling module 625 has been illustrated as writing the decryption key to an area of secure memory separate to the secure memory 610 within which the stream image data 615 is stored. However, it will be appreciated that in some examples the same secure memory may be used for storing the streamed image data 610 and the decryption key.

The encoded image data 305 for each graphics object to be displayed may then be read by the GPU 200. The GPU 200 is then able to decrypt the encrypted sub-image position data using the decryption key within the secure area of memory 350 and recombine the sub-images to obtain the graphics objects. The GPU 200 may then generate a composite image to be displayed based on the individual graphics objects, for example representing background images, foreground images, icons for messages, errors and warnings, dials, etc. Furthermore, such a composite image may be adapted depending on various conditions such as whether it is daytime or night time, a selected profile (e.g. comfort, sport) etc. The image data 310 for the composite image is then made available to a display controller 320 for displaying on a display 330, for example by way of the GPU 200 writing the image data 310 for the composite image back to system memory 263. In some alternative embodiments, the image data 310 for the composite image may be made available to the display controller 320 by way of writing the image data 310 for the composite image to a secure area of memory, such as performed in the example illustrated in FIG. 5.

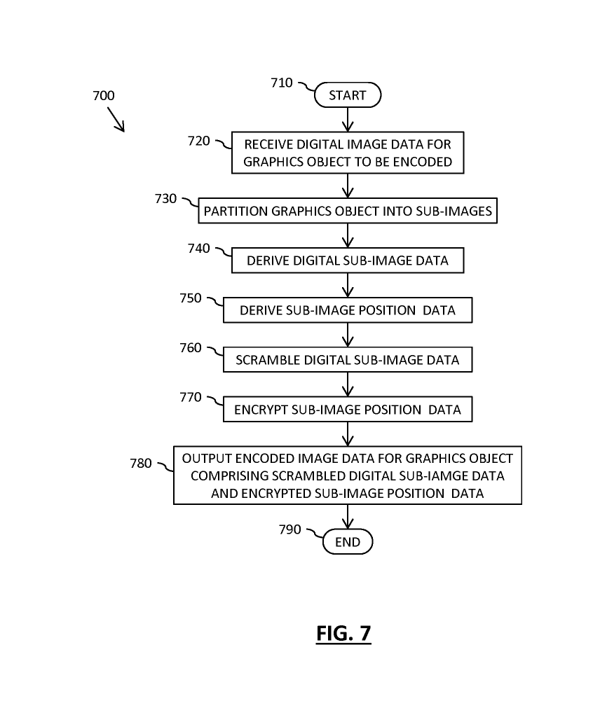

Referring now to FIG. 7, there is illustrated a simplified flowchart 700 of an example of a method of encoding image data defining a graphics object. The method starts at 710, and moves on to 720 where digital image data defining a graphics object to be encoded is received, for example loaded from a data storage device. Next, at 730, the graphics object is partitioned into sub-images. Such partitioning may be performed in any suitable manner. For example, and as described in greater detail above with reference to FIG. 4, dissection points within the graphics object may be determined. Having determined the dissection points, horizontal and/or vertical dissecting lines passing through the dissection points may then be used to dissect the graphics object into the plurality of sub-images. Digital sub-image data, for example comprising raw image data such as RGBA data, for each sub-image is then generated, or otherwise derived, at 740, from the digital image data defining the graphics object. Sub-image position data defining the relative positioning of the sub-images within the original graphics object is also generated, or otherwise derived, at 750, in order to enable the original graphics object to subsequently be recreated from the digital sub-image data for the plurality of sub-images.

The method then moves on to 760, where the digital sub-image data for the plurality of sub-images is scrambled. As described in greater detail above with reference to FIG. 4, any suitable scrambling function may be applied to the digital sub-image data that results in the relative positioning of the sub-images being changed (e.g. re-ordered) such that the relative position of the sub-images within the original graphics object is obfuscated. Next, at 770, the sub-image position data is encrypted. Encoded image data for the graphics object is then output, at 780, comprising the scrambled digital image data defining a plurality of sub-images and the encrypted sub-image position data.

The method then ends at 790.

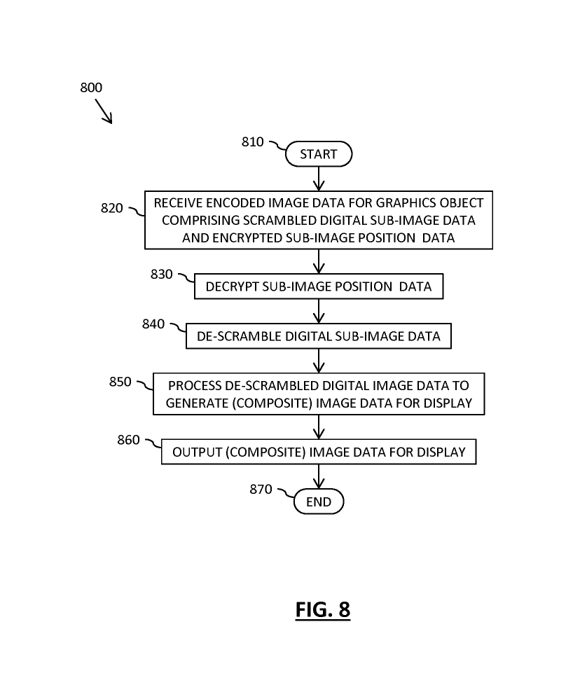

Referring now to FIG. 8, there is illustrated a simplified flowchart 800 of an example of a method of generating image data for display, such as may be implemented within the GPU 200 illustrated in any one of FIG.'S 2, 3, 5 and/or 6. The example method starts at 810, and moves on to 820 where encoded image data for at least one graphics object is received, the encoded image data comprising scrambled digital image data defining a plurality of sub-images and encrypted sub-image position data. Next, at 830, the encrypted sub-image position data is decrypted. The original graphics object may then be recreated by de-scrambling the sub-image data in accordance with the (decrypted) sub-image position data to derive digital image data defining the at least one graphics object, at 840. The de-scrambled digital image data defining the original graphics object may then be processed to generate digital image data defining an image for display. In some examples, (de-scrambled) digital image data defining multiple graphics objects, for example representing background images, foreground images, icons for messages, errors and warnings, dials, etc., may be processed to generate image data defining a composite image. Furthermore, such a composite image may be adapted depending on various conditions such as whether it is daytime or night time, a selected profile (e.g. comfort, sport, etc.). The generated image data for display is then output for display, at 860. For example, the generated image data for display may be output to memory, for example to system memory 263 as illustrated in FIG.'S 3 and 6, or to a secure area of memory 510 as illustrated in FIG. 5.

The method then ends at 870.

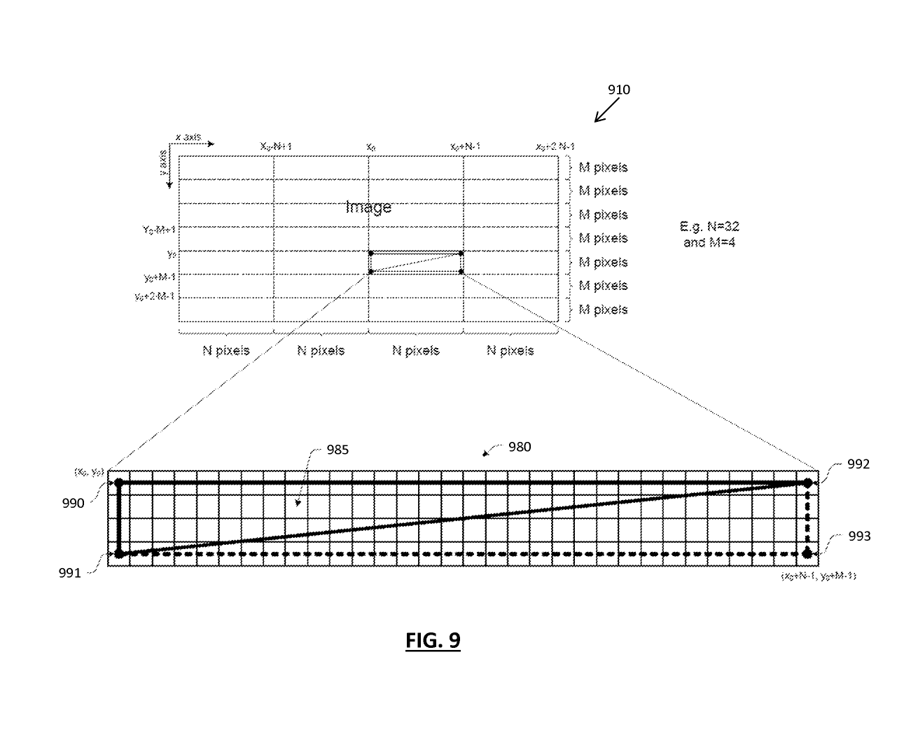

In accordance with some alternative examples of the present invention, it is contemplated that compression may be applied to the digital image data for at least some of the sub-images into which a graphics object is partitioned, to reduce the size of the encoded data for a graphics object. FIG. 9 schematically illustrates a simplified block diagram of a graphics object 910 partitioned into sub-images 980. In the example shown in FIG. 9, the graphics object 910 has been partitioned into sub-images 980 having an exemplary size dimension of 32×4 pixels 985. Each sub-image is defined on the basis of at least one geometric primitive. The term geometric primitive as such is used in the field of computer graphics and should be understood as relating to a geometric object, herein a two-dimensional geometric object. The geometric object may be further understood to relate to a definition of a geometric shape. Properties of the geometric object may include positioning and texturing of the object surface. At least one geometric primitive of the sub-image may be defined for each sub-image on the basis of geometry data defining a positioning (positional arrangement) of the at least one geometric primitive within the image space (i.e. within the original graphics object 910). The at least one geometric primitive represents geometrically each respective sub-image. In the example shown in FIG. 9, the sub-image is defined on the basis of two triangles. Each of the triangles is further defined on the basis of three position coordinates defining the positioning of the respective triangle within the image space. The coordinates 990, 991 and 992 for instance define the first triangle and the coordinates 991, 992 and 993 define the second triangle. The positions of the triangles within the image space are for instance defined by the coordinate 990 defining the position (x, y)=(x₀, y₀), coordinate 991 defining the position (x₀, y₀+M−1), wherein for instance M=3 as illustratively depicted in FIG. 9, coordinate 992 defining the position (x₀+N−1, y₀), wherein for instance N=32 as illustratively depicted in FIG. 9, and coordinate 993 defining the position (x₀+N−1, y₀+M−1). Accordingly, the positioning of the sub-image within the image space is defined on the basis of the positioning of the one or more geometric primitives, the totality of which defining the sub-image. It should be noted that the geometric primitives of a sub-image may have common coordinates as exemplarily illustrated in FIG. 9 with respect to coordinates 991 and 992.

In the illustrated example, the graphics object 910 is partitioned into sub-images 980 each of which defined on the basis of at least one geometric primitive. Each of the geometric primitives provides a two-dimensional surface, which is to be filled with an image detail of the unprocessed image in accordance with the positioning of the sub-image 980. The texture mapping operation is applied for texture lookup to determine the texture pixels, the so-called texels, from a texture image to fill the surface. The texture image data represents the data basis, to which the texture mapping operation is applied to fill the surface. In other words, a two-dimensional texture image is mapped to the surface of the graphic primitive. The two-dimensional texture image is defined in texture image space and a so-called texture lookup, which is the texture mapping, is performed using interpolated texture coordinates to determine the pixels to fill the surface of the graphic primitive.

The image data corresponding to each sub-image (in accordance with the positioning of the sub-image within the image space) may further be analysed in order to consider whether the image data thereof may be compressible or not. In response to the analysis result, a texture image is generated for each of the sub-images. For example, change of pixel values of the image data subset is describable on the basis of a texture mapping operation in the pixel value space of the texture image. Texture mapping operations may include for instance interpolation operations such as nearest neighbour sampling, linear interpolation, bilinear interpolation, cubic interpolation and be-cubic interpolation. Thus, data may be considered to be compressible if the retrieved pixel values of the subset of image data are describable on the basis of a texture mapping operation and selected pixel values of the subset of image data. Two examples are described below for the sake of a deeper understanding:

1. Image Data Subset with Similar Pixel Values:

The subset of the image data for the graphics object 910 corresponding to the sub-image 980 may be retrieved and it is determined from the subset of image data whether the pixel values of the retrieved subset of image data have the same pixel value or have similar values. Similar pixel values should be understood in that the pixel values differ within a predefined distance (colour range) in colour space. This means that the predefined distance in colour space allows for defining a measure of similarity of the pixel values. Quantifying metrics are known in the art to determine the difference or distance between two colours in colour space. For instance, such metrics make use of the Euclidean distance in a device independent colour space.

If the pixel values have the same value or similar pixel values then data of a texture image in compressed form may be defined, which has a single pixel with a pixel value corresponding to the same pixel value or a pixel value representative of the pixel values differing within a predefined distance in colour space. The representative pixel value may be an average pixel value with respect to the colour space. Hence, the texture image may comprise a single pixel having assigned the pixel value resulting from the analysis of the subset of image data. Texture mapping data is assigned to the geometry data of the sub-image, which texture mapping data enables mapping the defined compressed texture image onto the surface of the at least one geometric primitive of the sub-image.

2. Image Data Subset with Colour Gradient:

The subset of the image data for the graphics object 910 corresponding to the sub-image 980 may be retrieved and it is determined from the subset of image data whether the pixel values of the retrieved subset of image data change in accordance with a colour gradient extending over the range of the image data subset. The change of pixel values may follow a colour gradient within a predefined range of variation described by a distance in colour space.

If the pixel values are determined to show a colour gradient extending over the sub-image describable by initial gradient values and final gradient values then data of a texture image in compressed form is defined, which has pixels with pixel values corresponding to initial gradient values and pixels with pixel values corresponding to final gradient values. In particular, each of the gradient values comprises one or two initial gradient values depending on the interpolation mapping operation used. The texture mapping operation reconstructs the colour gradient by interpolation between the initial gradient values and the final gradient values to obtain the values lying in-between within the texture pixel space. The interpolation operation may be a linear interpolation operation on the basis of one gradient value and the final gradient value, a cubic interpolation operation on the basis of one gradient value and the final gradient value, a bi-linear interpolation operation on the basis of one or two gradient values and the one or two final gradient values, or bi-cubic interpolation operation on the basis of one or two gradient values and the one or two final gradient values. Hence, the texture image may comprise only two to four pixels having assigned the pixel values resulting from the analysis of the subset of image data. Texture mapping data is assigned to the geometry data of the sub-image, which texture mapping data enables mapping the defined compressed texture image onto the surface of the at least one geometric primitive of the sub-image.

If the subset of the image data for the graphics object 910 corresponding to the sub-image 980 is considered not to be compressible (e.g., the pixel values of the image data subset are not describable on the basis of a texture mapping operation and selected pixel values of the image data subset), data of a texture image in uncompressed form may be defined. The data of the texture image in uncompressed form comprises pixels with pixel values corresponding to the pixel values of the retrieved subset of image data. Texture mapping data is assigned to the geometry data of the sub-image, which texture mapping data enables mapping the defined texture image onto the at least one geometric primitive of the sub-image.

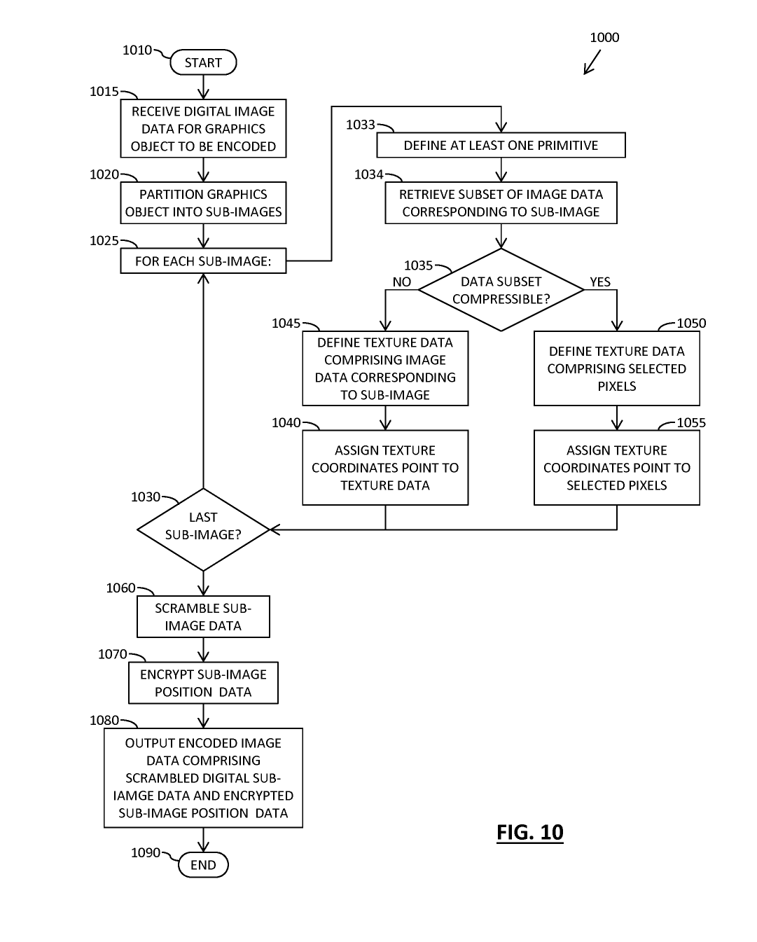

Referring now to FIG. 10, there is illustrated a simplified flowchart 1000 of an alternative example of a method of encoding image data defining a graphics object, whereby compression may be applied to the digital image data for at least some of the sub-images into which the graphics object is partitioned. The method of FIG. 10 starts at 1010, and moves on to 1015 where digital image data defining a graphics object to be encoded is received, for example loaded from a data storage device. Next, at 1020, the graphics object is partitioned into sub-images. The size(s) of the sub-image(s) may be defined in order to partition the image domain into an integer number of sub-images each one size corresponding to one of the at least one provided size dimension. The size dimension(s) of the sub-images may be further defined in accordance with the texture tile size of the target graphics subsystem, at which the finally obtained compressed image is to be decoded or uncompressed. The target graphics subsystem may have a limitation of the supported size of textures. The defining of the size dimension(s) of the sub-images allows for considering such limitations. Moreover, the size dimension(s) of the sub-images may be also defined by taking into account the properties of the image to be compressed, in particular the size of subsections of the image, the pixels of which parts have the same values. The size dimension may be varied in order to determine at least one size dimension of the sub-images resulting to a compressed image having an optional size. The at least one optional size dimension may be a trade-off between size of the compressed image and the capabilities and resource requirements of the target graphics subsystem.

Having partitioned the graphics object into sub-images, the method moves on to 1025 where, for each sub-image at least one geometric primitive is defined 1033. The at least one geometric primitive may be defined by assigning a set of vertices, which defines the positioning of the at least one geometric primitive in the image domain with respect to the image space. Accordingly, the at least one geometric primitive represents the geometry of the respective sub-image and the positioning of the respective sub-image with respect to the image space. Each vertex comprises for instance a two-dimensional position information, a coordinate, defining the positions x and y with respect to a predefined coordinate origin of the image space, which may be for instance located at the top left corner of the image as exemplarily illustrated in FIG. 9.

The so-called geometric primitive is a basic geometric object supported by the target graphics subsystem. For instance, a sub-image may be defined to comprise N×M pixels of the image. The set of vertices may comprise four vertices, which define two triangle primitives sharing two vertices. Provided that only rectangular sub-images are defined, two vertices may be sufficient to define such a rectangular sub-image, e.g. the coordinates 990 and 993 illustratively shown in FIG. 9. Those skilled in the art will understand that the compression encoding method as described is not limited to rectangular sub-images or to any specific primitive for defining an image subsection defined by each sub-image. The geometry of the sub-images may differ. Each sub-image spans a simply connected domain, which is a subdomain of the domain defined by the graphics object and the totality of sub-images defines a simply connected domain equal to the domain spanned by the graphics object, wherein the sub-images do not overlap each other, e.g., the domains of the sub-image are disconnected.

Further, the subset of image data of the graphics object corresponding to the respective sub-image is retrieved, at 1034, and the pixel values of the retrieved subset of data of the image are analysed in order to determine whether the image data of the subset is compressible on the basis of a texture mapping operation in pixel value space, at 1035.

If the pixels of the retrieved subset of the image data are re-constructible or derivable from one or more selected pixels on the basis of a texture mapping operation in pixel value space and the selected pixels are input parameters to the texture mapping operation, a texture image in compressed form is defined. This means that texture image data is defined, at 1050, comprising the selected pixels which are representative of the pixel of the retrieved subset of the image data. Texture mapping data (e.g. coordinates) is then generated, at 1055, for the set of vertices defining the analysed sub-image to point to the selected pixels of the texture image for the analysed sub-image. In this manner, compressed image data comprising the geometry data defining the geometric primitive, the texture image data comprising the selected pixels and texture mapping data for mapping the texture image data to the selected pixels is derived defining the sub-image.

Otherwise, if the pixels of the retrieved subset of the image data are not re-constructible or derivable from selected pixels representative of the pixel of the retrieved subset of the image data, texture image data in uncompressed form is defined. This means that texture image data is defined, at 1040, comprising the pixels with values of the subset of image data corresponding to the analysed sub-image. Texture mapping data (e.g. coordinates) is then generated, at 1045, for the set of vertices defining the analysed sub-image to point to the texture image data for this analysed sub-image. The subset of data of the uncompressed image, which corresponds to the analysed sub-image, may be copied or extracted to create the texture image data. In this manner, uncompressed image data comprising the geometry data defining the geometric primitive, the texture image data representing the pixels within the retrieved subset of image data of the graphics object corresponding to the sub-image and texture mapping data for mapping the texture image data to the pixels within the sub-image.

Once the image data for the last sub-image of the graphics object has been generated, at 1030, the method moves on to 1060, where the digital sub-image data for the plurality of sub-images is scrambled. As described in greater detail above with reference to FIG. 4, any suitable scrambling function may be applied to the digital sub-image data that results in the relative positioning of the sub-images being changed (e.g. re-ordered) such that the relative position of the sub-images within the original graphics object is obfuscated. Next, at 1070, the sub-image position data is encrypted. Encoded image data for the graphics object is then output, at 1080, comprising the scrambled digital image data defining a plurality of sub-images and the encrypted sub-image position data.

The method then ends at 1090.

In this manner, the method illustrated in FIG. 10 comprises, for each sub-image:
defining at least one geometric primitive on the basis of geometry data defining a positioning of the (at least one) geometric primitive within the image space of the graphics object, wherein the geometric primitive(s) represents geometrically the sub-image;
retrieving a subset of (raw) image data of the graphics object corresponding to the sub-image;
determining whether pixels of the retrieved subset are re-constructible from one or more selected pixels as input parameters on the basis of a texture mapping operation in the pixel value space, wherein the selected pixels are representative of the subset of image data and input parameters to the texture mapping operation in pixel value space; and
if the pixels of the retrieved subset are re-constructible, deriving digital image data for the sub-image in compressed form, wherein a compressed form of said digital image data comprises geometry data defining the geometric primitive, texture image data comprising the selected pixels and texture mapping data for mapping the texture image data to the selected pixels;
otherwise defining digital image data for the sub-image in uncompressed form.

In some examples, and as illustrated in FIG. 10, the uncompressed form of the digital image data may comprise the geometry data defining the geometric primitive, the texture image data representing the pixels within the retrieved subset of image data of the graphics object corresponding to the sub-image and texture mapping data for mapping the texture image data to the pixels within the sub-image. Alternatively, in some examples it is contemplated that the uncompressed form of the digital image data may comprise raw image data corresponding to the retrieved subset of image data of the graphics object corresponding to the sub-image.

Examples of such a sub-image data compression technique is described in greater detail in the Applicant's co-pending U.S. patent application Ser. No. 14/310,005 filed on 20 Jun. 2014, the content of which is incorporated herein by reference. It will be appreciated that the present invention is not limited to such examples of sub-image data compression techniques, and it is contemplated that any suitable form of image data compression may additionally/alternatively be implemented for compressing the digital image data defining some or all of the sub-images. In particular, it is contemplated that such compressed image data is not limited to compressed image data comprising geometry data, texture mapping data and texture image data. For example, raw pixel data may be compressed using well known data compression techniques that exploit statistical redundancy within the data being compressed.

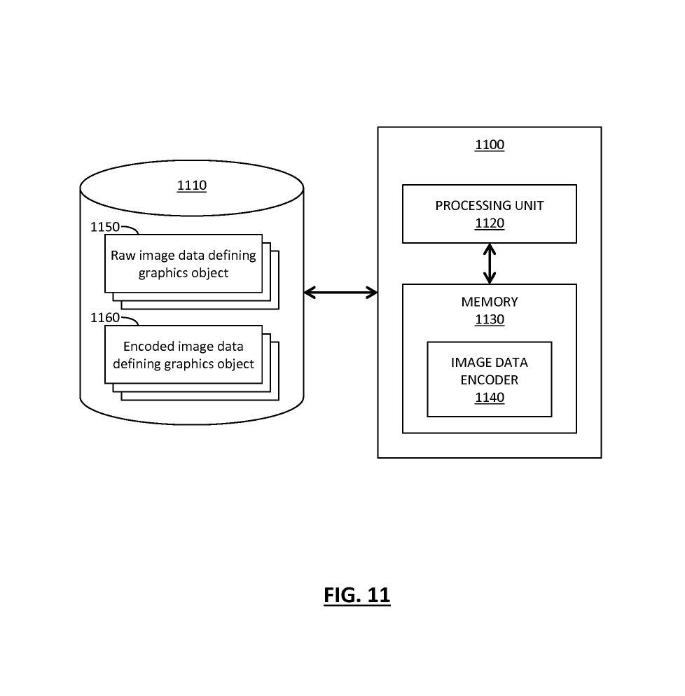

Referring now to FIG. 11, there is illustrated a simplified block diagram of an example of a processing device 1100 for generating image data for display. The processing device 1100 comprises at least one processing unit 1120 operably coupled to a non-transitory computer program product, illustrated as memory 1130 in FIG. 11, having executable program code 1140 stored therein for encoding image data defining a graphics object. For example, the executable program code 1140 may be arranged to cause the processing unit to implement one of the methods illustrated in FIG. 7 or FIG. 10 and described above. In this manner, the processing unit 1120 is arranged to receive digital image data defining a graphics object, partition the graphics object into a plurality of sub-images, derive digital image data for each sub-image, the digital image data defining the respective sub-image, derive sub-image position data defining the relative positioning of the sub-images within the graphics object, scramble the digital image data for the plurality of sub-images, encrypt sub-image position data, and output encoded image data defining the graphics object comprising the scrambled sub-image data and the encrypted sub-image position data. For example, and as illustrated in FIG. 11, the processing device 110 may be operably coupled to one or more data storage devices, indicated generally at 1110 in which raw image data 1150 defining one or more graphics objects is stored. The processing unit 1120 may be arranged to load the raw digital image data 1150 to be encoded from the data storage device(s) 1110 into memory 1130, and to store (output) the encoded image data 1160 within the data storage device(s) 1110. It will be appreciated that the processing unit 1120 may be arranged to store (output) the encoded image data 1160 within the same data storage device(s) 1110 from which the raw image data 1150 was loaded, or within a different data storage device(s) 1110 to that which the raw image data 1150 was loaded.

The invention may be implemented in a computer program for running on a computer system, at least including code portions for performing steps of a method according to the invention when run on a programmable apparatus, such as a computer system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a tangible and non-transitory computer readable storage medium or transmitted to the computer system via a computer readable transmission medium. All or some of the computer program may be provided on computer readable media permanently, removably or remotely coupled to an information processing system. The tangible and non-transitory computer readable media may include, for example and without limitation, any number of the following: magnetic storage media including disk and tape storage media; optical storage media such as compact disk media (e.g., CD-ROM, CD-R, etc.) and digital video disk storage media; non-volatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the scope of the invention as set forth in the appended claims and that the claims are not limited to the specific examples described above.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Any arrangement of components to achieve the same functionality is effectively ‘associated’ such that the desired functionality is achieved. Hence, any two components herein combined to achieve a particular functionality can be seen as ‘associated with’ each other such that the desired functionality is achieved, irrespective of architectures or intermediary components. Likewise, any two components so associated can also be viewed as being ‘operably connected,’ or ‘operably coupled,’ to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms ‘a’ or ‘an,’ as used herein, are defined as one or more than one. Also, the use of introductory phrases such as ‘at least one’ and ‘one or more’ in the claims should not be construed to imply that the introduction of another claim element by the indefinite articles ‘a’ or ‘an’ limits any particular claim containing such introduced claim element to inventions containing only one such element, even when the same claim includes the introductory phrases ‘one or more’ or ‘at least one’ and indefinite articles such as ‘a’ or ‘an.’ The same holds true for the use of definite articles. Unless stated otherwise, terms such as ‘first’ and ‘second’ are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A method of encoding image data defining a graphics object, the method comprising:
partitioning the graphics object into a plurality of sub-images;
deriving digital image data for each sub-image, the digital image data defining the respective sub-image;
deriving sub-image position data defining the relative positioning of the sub-images within the graphics object;
scrambling the digital image data for the plurality of sub-images;
encrypting sub-image position data; and
outputting encoded image data defining the graphics object comprising the scrambled sub-image data and the encrypted sub-image position data.

2. The method of claim 1, wherein partitioning the graphics object into a plurality of sub-images comprises determining at least one dissection point within the graphics object, and dissecting the graphics object along horizontal and/or vertical dissection lines running through the at least one dissection point.

3. The method of claim 2, wherein the at least one dissection point is determined based at least partly on at least one of:
predefined coordinates;
coordinates derived based on at least one predefined criteria; and
randomly derived coordinates.

4. The method of claim 1, wherein the graphics object is partitioned into a plurality of sub-images comprises based on at least one of predefined and dynamically defined sub-image block sizes.

5. The method of claim 1, wherein the digital image data defining respective sub-images comprises at least one from a group comprising at least one of:
pixel data; and
geometry data, texture mapping data and texture image data.

6. The method of claim 1, wherein the digital image data defining at least one of the respective sub-images comprises compressed image data.

7. The method of claim 6, wherein the method further comprises, for each sub-image:
defining at least one geometric primitive on the basis of geometry data defining a positioning of the at least one geometric primitive within the image space of the graphics object, wherein said at least one geometric primitive represents geometrically the sub-image;
retrieving a subset of image data of the graphics object corresponding to the sub-image;
determining whether pixels of the retrieved subset are re-constructible from one or more selected pixels as input parameters on the basis of a texture mapping operation in the pixel value space, wherein the selected pixels are representative of the subset of image data and input parameters to the texture mapping operation in pixel value space; and
if the pixels of the retrieved subset are re-constructible, deriving digital image data for the sub-image in compressed form, wherein a compressed form of said digital image data comprises geometry data defining the geometric primitive, texture image data comprising the selected pixels and texture mapping data for mapping the texture image data to the selected pixels;
otherwise defining digital image data for the sub-image in uncompressed form.

8. The method of claim 7, wherein the uncompressed form of the digital image data comprises the geometry data defining the geometric primitive, the texture image data representing the pixels within the retrieved subset of image data of the graphics object corresponding to the sub-image and texture mapping data for mapping the texture image data to the pixels within the sub-image.

9. A processing device for encoding image data defining graphics objects, said processing device comprises at least one processing unit arranged to:
receive digital image data defining a graphics object;
partition the graphics object into a plurality of sub-images;
derive digital image data for each sub-image, the digital image data defining the respective sub-image;
derive sub-image position data defining the relative positioning of the sub-images within the graphics object;
scramble the digital image data for the plurality of sub-images;
encrypt sub-image position data; and
output encoded image data defining the graphics object comprising the scrambled sub-image data and the encrypted sub-image position data.

10. A method of generating image data for display, the method comprising:
receiving encoded image data defining at least one graphics object, the encoded image data comprising scrambled sub-image data and encrypted sub-image position data;
decrypting the encrypted sub-image position data;
de-scrambling the scrambled sub-image data in accordance with the decrypted sub-image position data to derive digital image data defining the at least one graphics object;
processing the derived digital image data defining the at least one graphics object to generate digital image data defining an image for display; and
outputting the digital image data defining the image for display.

11. The method of claim 10, wherein the digital image data defining at least one of the respective sub-images comprises compressed image data.

12. The method of claim 10, wherein the digital image data defining at least one sub-image comprises digital image data for the sub-image in compressed form, wherein a compressed form of said digital image data comprises geometry data defining the geometric primitive, texture image data comprising the selected pixels and texture mapping data for mapping the texture image data to the selected pixels.

13. A processing device for generating image data for display, said processing device comprises at least one processing unit arranged to:
receive encoded image data defining at least one graphics object, the encoded image data comprising scrambled sub-image data and encrypted sub-image position data;
decrypt the encrypted sub-image position data;
de-scramble the scrambled sub-image data in accordance with the decrypted sub-image position data to derive digital image data defining the at least one graphics object;
process the derived digital image data defining the at least one graphics object to generate digital image data defining an image for display; and
output the digital image data defining the image for display.

14. The processing device of claim 13, wherein the digital image data defining at least one of the respective sub-images comprises compressed image data.

15. The processing device of claim 13, wherein the digital image data defining at least one sub-image comprises digital image data for the sub-image in compressed form, wherein a compressed form of said digital image data comprises geometry data defining the geometric primitive, texture image data comprising the selected pixels and texture mapping data for mapping the texture image data to the selected pixels.

16. The processing device of claim 13, wherein the at least processing unit comprises a graphics processing unit.

17. The processing device of claim 13 implemented within an integrated circuit device comprising at least one die within a single integrated circuit package.

18. (canceled)

19. (canceled)

20. (canceled)
